(19) United States
(12) Patent Application Publication
(10) Pub. No.: US 2011/0109662 A1
(43) Pub. Date: May 12, 2011

(54) DRIVING APPARATUS AND DRIVING METHOD OF LIQUID CRYSTAL DISPLAY

(75) Inventors: Sang-Mi CHO, Seongnam-si (KR); Young-Min CHOI, Hwaseong-si (KR); Sang-Chul LEE, Asan-si (KR); Jae-Seob CHUNG, Seoul (KR); Jong-Hee NA, Asan-si (KR); Dong-Ki LEE, Seoul (KR)

(73) Assignee: SAMSUNG ELECTRONICS CO., LTD., Suwon-si (KR)

(21) Appl. No.: 12/902,553

(22) Filed: Oct. 12, 2010

(30) Foreign Application Priority Data
Nov. 9, 2009 (KR) 10-2009-0107655

(51) Int. Cl. G09G 5/10; G09G 3/36

(52) U.S. Cl. 345/690; 345/88

(57) ABSTRACT

A driving apparatus for a liquid crystal display, which includes a first pixel, a second pixel and a third pixel that display different colors, includes: an image signal compensation unit that compensates input image signals corresponding to the first pixel, the second pixel, and the third pixel to generate compensated input image signals; and a data driver that supplies data voltages to the first pixel, the second pixel and the third pixel based on the compensated input image signals. The image signal compensation unit shifts a value of the input image signal corresponding to the first pixel by a first value with respect to a common voltage, shifts a value of the input image signal corresponding to the second pixel by a second value with respect to the common voltage, and shifts a value of the input image signal corresponding to the third pixel by a third value with respect to the common voltage.

This application claims priority to Korean Patent Application No. 10-2009-0107655, filed on Nov. 9, 2009, and all the benefits accruing therefrom under 35 U.S.C. §119, the content of which in its entirety is herein incorporated by reference.

### BACKGROUND OF THE INVENTION

(1) Field of the Invention

The present invention relates to a driving apparatus for a liquid crystal display, and a driving method thereof

(2) Description of the Related Art

A liquid crystal display (“LCD”) is a widely used type of flat panel display. The LCD typically includes two display panels provided with electric field generating electrodes, such as pixel electrodes and a common electrode, and a liquid crystal layer interposed between the two display panels. In the LCD, voltages are applied to the electric field generating electrodes to generate an electric field in the liquid crystal layer. Due to the generated electric field, liquid crystal molecules in the liquid crystal layer are aligned, and a polarization of light incident to the liquid crystal layer is thereby controlled to display an image on the LCD.

To display a full color image on the LCD, a color filter is used, and the color filter may be disposed on a substrate that includes a switching element connected to each pixel electrode. In this case, the color filter may be made of an organic insulator, and a thickness of a particular color filter may be different from other color filters, based on a color that the particular color filter displays. Due to the difference in thicknesses between different color filters, a cell gap, which is a thickness of the liquid crystal cell, differs according to the color of each pixel.

When the cell gap changes according to the color of each pixel, a reaction degree, for a given, same common voltage, of the liquid crystal layer differs according to the color of each pixel. As a result, it is difficult to accurately display an image having a desired color.

Also, when driving the liquid crystal display using an inversion method, for example, the reaction degree of the liquid crystal layer also differs with respect to a positive data voltage and a negative data voltage according to the color of each pixel.

### BRIEF SUMMARY OF THE INVENTION

The present invention provides a liquid crystal display (“LCD”), including a color filter made of an organic insulator and having different thicknesses, that accurately displays a desired color by using color compensation.

According to an exemplary embodiment of the present invention, a driving apparatus for a liquid crystal display, which includes a first pixel, a second pixel and a third pixel that display different colors, includes: an image signal compensation unit that compensates input image signals corresponding to the first pixel, the second pixel and the third pixel to generate compensated input image signals; and a data driver that supplies data voltages to the first pixel, the second pixel and the third pixel based on the compensated input image signals. The image signal compensation unit shifts a value of the input image data corresponding to the first pixel by a first value with respect to a common voltage, shifts a value of the input image data corresponding to the second pixel by a second value with respect to the common voltage, and shifts a value of the input image data corresponding to the third pixel by a third value with respect to the common voltage.

The first pixel may include a first color filter for displaying a first color, the second pixel may include a second color filter for displaying a second color, the third pixel may include a third color filter for displaying a third color, and the first color filter, the second color filter and the third color filter may include an organic insulator and have different thicknesses from each other.

Magnitudes of the first value, the second value and the third value may be determined based on the thicknesses of the first color filter, the second color filter and the third color filter.

The magnitudes of the first value, the second value and the third value, with respect to the common voltage, may be different for a case in which the input image data has a positive value than for a case in which the input image data has a negative value.

The image signal compensation unit may include a memory unit for storing values of lookup tables corresponding to the first pixel, the second pixel and the third pixel, and may further include a compensation unit for compensating the input image signals corresponding to the first pixel, the second pixel and the third pixel based on the values in the lookup tables.

The first pixel may include a first color filter for displaying the first color, the second pixel may include a second color filter for displaying the second color, and the third pixel may include a third color filter for displaying the third color, the first color filter, the second color filter and the third color filter may include an organic insulator and may have different thicknesses from each other. The lookup tables may have values determined by the thicknesses of the first color filter, the second color filter and the third color filter.

The lookup tables corresponding to the first pixel, the second pixel and the third pixel may be different for the case in which the input image data has the positive value and the case in which the input image data has the negative value.

The lookup table for the case in which the input image data has the negative value, with respect to the common voltage, may include values, shifted by a predetermined value, from the lookup table for the case in which the input image data has the positive value.

In another exemplary embodiment of the present invention, a driving method for a liquid crystal display, which includes a first pixel, a second pixel and a third pixel that display different colors, includes: receiving input image signals corresponding to the first pixel, the second pixel and the third pixel; compensating the input image signals corresponding to the first pixel, the second pixel and the third pixel to generate compensated input image signals; and supplying data voltages to the first pixel, the second pixel and the third pixel based on the compensated input image signals. The compensating the input image signals includes shifting a value of the input image data corresponding to the first pixel by a first value with respect to a common voltage, shifting a value of the input image data corresponding to the second pixel by a second value with respect to the common voltage, and shifting a value of the input image data corresponding to the third pixel by a third value with respect to the common voltage.

Thus, according to the exemplary embodiments of the present invention described herein, when a color filter of a liquid crystal display is made of an organic insulator and a thickness of the color filter is different from other color filters, according to a color displayed in each pixel, a positive data voltage and a negative data voltage are compensated according to the color displayed in each pixel such that a correct and desired color is accurately displayed.

Also, according to the thickness difference of the color filter, lookup tables values are shifted by a predetermined value according to the color displayed in each pixel, and are used for the compensation of the positive data voltage and the negative data voltage such that the color is compensated without requiring an additional driver or circuit portion, and a cost of the driver and the liquid crystal display is thereby substantially reduced.

### BRIEF DESCRIPTION OF THE DRAWINGS

The above and other aspects and features of the present invention will become more apparent by describing in further detail exemplary embodiments thereof with reference to the accompanying drawings, in which:

FIG. 1 is a block diagram of an exemplary embodiment of a liquid crystal display according to the present invention;

FIG. 2 is an equivalent circuit diagram of an exemplary embodiment of one pixel of a liquid crystal display according to the present invention;

FIG. 3 is a partial cross-sectional view of a portion of an exemplary embodiment of a liquid crystal panel assembly in a liquid crystal display according to the present invention;

FIG. 4 is a block diagram of an exemplary embodiment of an image signal compensation unit according to the present invention;

FIG. 5 is a block diagram of an exemplary embodiment of a data table in a memory unit according to the present invention; and

FIGS. 6A through 6C are signal level diagrams showing an exemplary embodiment of a method of compensating an input image signal according to a color displayed in each pixel of a liquid crystal display according to the present invention.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

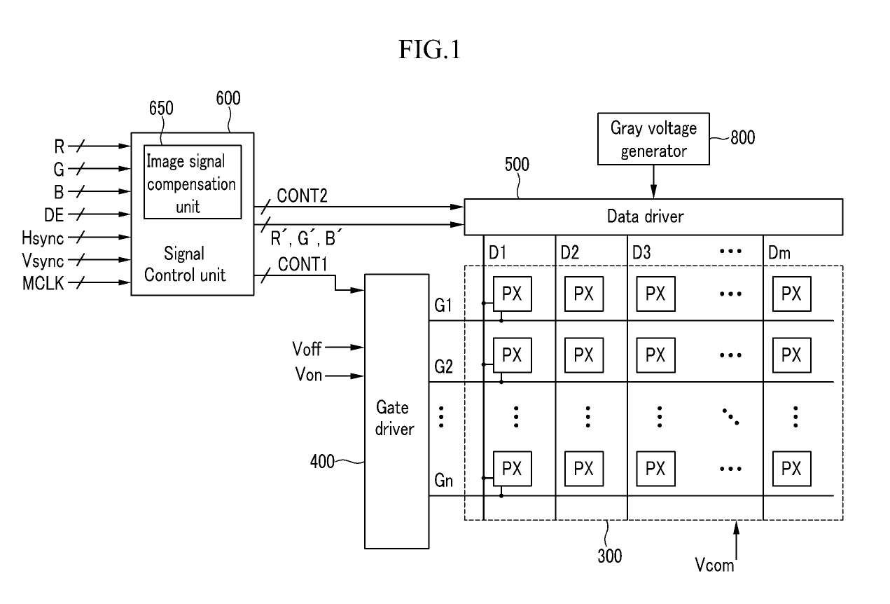

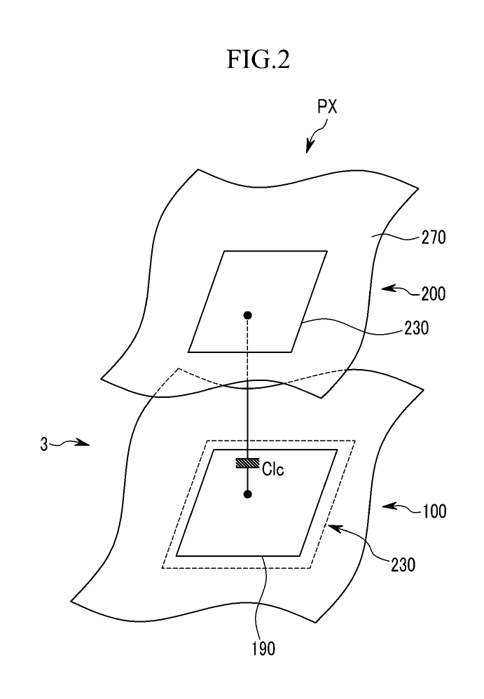

A liquid crystal display (“LCD”) according to an exemplary embodiment of the present invention will now be described in further detail with reference to FIG. 1 and FIG. 2.

FIG. 1 is a block diagram of an exemplary embodiment of an LCD according to the present invention, and FIG. 2 is an equivalent circuit diagram of one pixel of the LCD.

Referring to FIG. 1, a liquid crystal display according to an exemplary embodiment of the present invention includes a liquid crystal panel assembly 300, a gate driver 400, a data driver 500, a gray voltage generator 800 and a signal controller 600, which, in an exemplary embodiment, is a signal control unit 600. The signal controller 600, e.g, the signal control unit 600, includes an image signal compensation unit 650.

As shown in FIG. 1, the liquid crystal panel assembly 300 includes a plurality of signal lines G1-Gn and D1-Dm, and a plurality of pixels PX arranged in a substantially matrix pattern, e.g., arranged in pixel rows and pixel columns.

As shown in FIG. 2, the liquid crystal panel assembly 300 includes a lower panel 100 and an upper panel 200 disposed opposite to, e.g., facing, the lower panel 100, and a liquid crystal layer 3 interposed between the lower panel 100 and the upper panel 200.

The plurality of signal lines G1-Gn and D1-Dm includes gate lines G1 to Gn for transmitting gate signals (also referred to as “scanning signals”) and data lines D1 to Dm for transmitting a data voltage. The gate lines G1 to Gn are arranged substantially parallel to each other and extend along a first, approximately row, direction, and the data lines D1 to Dm are arranged substantially parallel to each other and extend along a second, substantially column, direction that is substantially perpendicular to the first direction.

Each pixel PX of the plurality of pixels PX, such as a pixel PX connected to an i-th (where i=1, 2, . . . , n) gate line Gi and a j-th (where j=1, 2, . . . , m) data line Dj, for example, includes a switching element (not shown) connected to the I-th gate line Gi and the j-th data line Dj, and a liquid crystal capacitor Clc. In an exemplary embodiment, the switching element is also connected to a storage capacitor (not shown), although the storage capacitor may be omitted in additional exemplary embodiments.

In an exemplary embodiment, the switching element (not shown) is a three terminal element such as a thin film transistor (“TFT”), for example, and is disposed on the lower panel 100. A control terminal of the TFT is connected to the i-th gate line Gi, an input terminal of the TFT is connected to the j-th data line Dj, and an output terminal of the TFT is connected to the liquid crystal capacitor Clc and the storage capacitor (not shown).

The liquid crystal capacitor Clc has two terminals, including a pixel electrode 190 (FIG. 2) of the lower panel 100 and a common electrode 270 of the upper panel 200. The liquid crystal layer 3 disposed between the pixel electrode 190 and the common electrode 270 is a dielectric material of the liquid crystal capacitor Clc. The pixel electrode 190 is connected to the switching element, and the common electrode 270 is disposed on an entire surface of the upper panel 200 and receives a common voltage Vcom. Although not shown as such in FIG. 2, in another exemplary embodiment, the common electrode 270 may be disposed on the lower panel 100, and at least one of the pixel electrode 190 and the common electrode 270 may have a substantially rectilinear shape and/or a bar shape.

The storage capacitor (not shown) is an auxiliary capacitance for the liquid crystal capacitor Clc and is formed as a separate signal line (not shown) provided on the lower panel 100, with a portion of the pixel electrode 190 overlapping it and an insulator interposed therebetween. In an exemplary embodiment, a predetermined voltage, such as the common voltage Vcom, for example, is applied to the separate signal line. However, the storage capacitor may be formed by the pixel electrode 190 and an overlapping portion of a previous gate line that overlaps the pixel electrode 190 with the insulator disposed therebetween.

For color display using spatial division, each pixel PX of an LCD according to one or more exemplary embodiments uniquely represents one color of the primary colors (e.g., red, green and blue). In other exemplary embodiments, which display a color image using temporal division, each pixel PX sequentially represents the primary colors. Thus, in an exemplary embodiment, a spatial or temporal sum of the primary colors is recognized as a desired color. Specifically, for example, FIG. 2 shows spatial division, in which each pixel PX includes a color filter 230 representing, e.g., corresponding to, one of the primary colors in an area of the lower panel 100 corresponding to the pixel electrode 190. The color filter 230 may include, e.g., may be made of, an organic insulator.

At least one polarizer (not shown), which polarizes light incident thereto, is provided in the liquid crystal panel assembly 300.

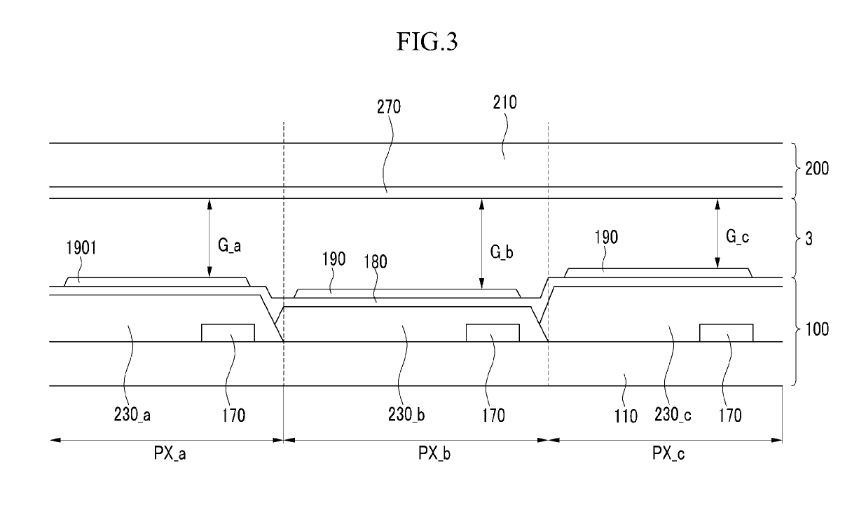

An exemplary embodiment of the liquid crystal panel assembly 300 in an LCD according to the present invention will now be described in further detail with reference to FIG. 3. FIG. 3 is a partial cross-sectional view of a portion of an exemplary embodiment of a liquid crystal panel assembly in a liquid crystal display according to the present invention.

Referring to FIG. 3, an LCD according to an exemplary embodiment of the present invention includes the lower panel 100 and the upper panel 200 facing each other and the liquid crystal layer 3 interposed therebetween, as described above with reference to FIG. 2.

The lower panel 100 includes a thin film structure 170 disposed on an insulation substrate 110 and including signal lines such as the gate lines G and the data lines D, and the switching element, as well as a first color filter 230_{—}a, a second color filter 230_{—}b and a third color filter 230_{—}c disposed on the thin film structure 170, an insulating layer 180 disposed on the first color filter 230_{—}a, the second color filter 230_{—}b and the third color filter 230_{—}c, and the pixel electrode 190 disposed on the insulating layer 180. Although not shown in FIG. 3, the insulating layer 180 and the first color filter 230_{—}a, the second color filter 230_{—}b and the third color filter 230_{—}c may include a contact hole through which the pixel electrode 190 is physically and electrically connected to the thin film structure 170.

The upper panel 200 includes the common electrode 270 disposed on an insulation substrate 210.

The liquid crystal layer 3 includes a plurality of liquid crystal molecules (not shown).

As shown in FIG. 3, the liquid crystal display according to an exemplary embodiment of the present invention includes a first pixel PX_a, a second pixel PX_b and a third pixel PX_c. Additionally, in an exemplary embodiment, the first pixel PX_a, the second pixel PX_b and the third pixel PX_c each display a different color, such as one of the primary colors, for example. In the exemplary embodiment shown in FIG. 3, the first color filter 230_{—}a is disposed in, e.g., corresponding to, the first pixel PX_a, the second color filter 230_{—}b is disposed in the second pixel PX_b, and the third color filter 230_{—}c is disposed in the third pixel PX_c.

The first color filter 230_{—}a, the second color filter 230_{—}b and the third color filter 230_{—}c correspond to, e.g., display, different colors, and in an exemplary embodiment the colors are the primary colors, as described in greater detail above. The first color filter 230_{—}a, the second color filter 230_{—}b and the third color filter 230_{—}c may include, e.g., may be made of, an organic insulator. In an exemplary embodiment, thicknesses of the first color filter 230_{—}a, the second color filter 230_{—}b and the third color filter 230_{—}c are different from each other.

Thus, as shown in FIG. 3, since the first color filter 230_{—}a, the second color filter 230_{—}b and the third color filter 230_{—}c have different thicknesses from each other, a thickness of the liquid crystal layer 3 varies, such that a first cell gap G_a, a second cell gap G_b and a third cell gap G_c, representing respective associated intervals between the lower panel 100 and the upper panel 200, are different for each of the pixels PX_a, PX_b and PX_c, respectively.

A driving apparatus of an LCD according to an exemplary embodiment of the present invention will now be described in further detail with reference to FIG. 1.

Referring again to FIG. 1, the gray voltage generator 800 generates all gray voltages or, alternatively, generates a predetermined number of gray voltages (or reference gray voltages) related to a transmittance of the pixels PX. The (reference) gray voltages may include one set of gray voltages, having a positive value with respect to the common voltage Vcom, and another set of gray voltages having a negative value with respect to the common voltage Vcom.

The gate driver 400 is connected to the gate lines G1 to Gn of the liquid crystal panel assembly 300, and applies the gate signals, obtained by combining a gate-on voltage Von and a gate-off voltage Voff, to the gate lines G1 to Gn.

The data driver 500 is connected to the data lines D1 to Dm of the liquid crystal panel assembly 300, and selects the gray voltages from the gray voltage generator 800 and applies the selected gray voltages to the data lines D1-Dm as the data voltages. However, in an exemplary embodiment in which the gray voltage generator 800 does not supply a voltage for all grays, but instead supplies only a predetermined number of reference gray voltages, the data driver 500 divides the reference gray voltages to generate the data voltages.

The signal controller 600 controls the gate driver 400 and the data driver 500. In an exemplary embodiment, the signal controller 600 includes the image signal compensation unit 650, as will be described in greater detail below.

Each of the gate driver 400, the data driver 500, the gray voltage generator 800 and the signal controller 600 may be directly disposed on, e.g., mounted on, the liquid crystal panel assembly 300 in the form of at least one integrated circuit (“IC”) chip, and/or may be mounted on a flexible printed circuit film (not shown) and mounted on the liquid crystal panel assembly 300 in the form of a tape carrier package (“TCP”), for example, and/or may be mounted on a separate printed circuit board (not shown). In another exemplary embodiment, the gate driver 400, the data driver 500, the gray voltage generator 800 and the signal controller 600 may be integrated together with the liquid crystal panel assembly 300 with, for example, the signal lines G1-Gn and D1-Dm and the TFT switching element. In an exemplary embodiment, the gate driver 400, the data driver 500, the gray voltage generator 800 and the signal controller 600 may be integrated into a single chip, although at least one of the abovementioned components, or at least one circuit forming the abovementioned components, may be disposed outside, e.g., external to, the single chip.

An operation of an exemplary embodiment of a liquid crystal display will now be described in further detail with reference to FIG. 1.

In an exemplary embodiment, the signal controller 600 receives input image signals R, G, B and an input control signal to control the display of the input image signals R, G, B from a graphics controller (not shown). The input image signals R, G, B contain luminance information for each pixel PX. The luminance information has a predetermined number of grays, such as 1024=2¹⁰, 256=2⁸ or 64=2⁶, for example, although additional exemplary embodiments are not limited thereto. Specific examples of the input control signals include a vertical synchronization signal Vsync, a horizontal synchronizing signal Hsync, a main clock signal MCLK and a data enable signal DE.

The signal controller 600 processes the input image signals R, G, B to operate the liquid crystal panel assembly 300 based on the input image signals R, G, B, and generates a gate control signal CONT1 and a data control signal CONT2 based thereon. The signal controller 600 outputs the gate control signal CONT1 to the gate driver 400, and outputs the data control signal CONT2 and compensation image signals R′, G′, B′ to the data driver 500. In an exemplary embodiment, the image signal compensation unit 650 of the signal controller 600 compensates the input image signals R, G, B to be suitable for the thickness of the color filter of the liquid crystal panel assembly 300, as will be described in greater detail below.

The gate control signal CONT1, which, in an exemplary embodiment is a scan control signal CONT1, includes an image scanning start signal (not shown) to instruct a start of image scanning, and at least one clock signal to control an output cycle of the gate-on voltage Von. The scan control signal CONT1 may further include an output enable signal (not shown) to define a sustaining time, e.g., a period, of the gate-on voltage Von.

The data control signal CONT2 includes a horizontal synchronization start signal (not shown) for a transmission start of digital image data (not shown) for one column of the pixels PX, a load signal (not shown) to instruct the analog data voltage to be applied to the image data lines D1-Dm, and a data clock signal (not shown). The data control signal CONT2 may further include an inversion signal (not shown) that inverts a voltage polarity of the data voltage with respect to the common voltage Vcom. Hereinafter, “data signal polarity” denotes the voltage polarity of the data signal with respect to the common voltage Vcom.

The data driver 500 receives the compensation image signals R′, G′, B′ for a column of the pixels PX, and selects gray voltages corresponding to the compensation image signals R′, G′, B′ according to, e.g., based on, the data control signal CONT2 from the signal controller 600 to convert the compensation image signals R′, G′, B′ into an analog data signal. Then, the analog data signal is supplied to the data lines D1-Dm.

The gate driver 400 supplies the gate-on voltage Von to the gate lines G1-Gn according to the gate control signal CONT1 from the signal controller 600, thereby turning on the TFT switching element (not shown) connected to the gate lines G1-Gn. Thus, the data voltage supplied to the data lines D1-Dm is supplied to a corresponding pixel PX through the turned-on switching element.

A difference between a voltage of the data signal applied to the pixels PX and the common voltage Vcom is a charged voltage in the liquid crystal capacitor Clc, e.g., is a pixel voltage. Alignment of the liquid crystal molecules (not shown) in the liquid crystal layer 3 varies according to a magnitude of the pixel voltage, to change a polarization of light that passes through the liquid crystal layer 3. A transmittance of the light is changed by a polarizer, according to the change in the polarization, such that the pixel PX displays a luminance corresponding to the gray level of the input image signal R, G, B.

In a horizontal period (“1H”) is substantially the same as one period of the horizontal synchronization signal Hsync and the data enable signal DE, and the aforementioned operations are repeatedly performed to sequentially apply the gate-on voltage Von to all of the gate lines G1 to Gn, so that the data signals are applied to all the pixels PX. As a result, one frame of the image is displayed.

When one frame ends a next frame starts, a state of the inversion signal applied to the data driver 500 is controlled so that a polarity of the data signal applied to each of the pixels is opposite to a polarity in the previous frame (e.g., frame inversion). In another exemplary embodiment, in one frame, the polarity of the data signal flowing through one data line may be inverted, based on the inversion signal (e.g., row inversion and/or dot inversion). In addition, the polarities of the data signals applied to the pixel row may be different from each other (e.g., column inversion and/or dot inversion).

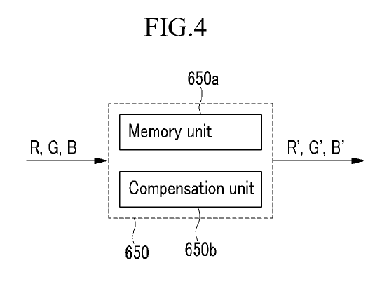

An image signal compensation of the image signal compensation unit 650 of the signal controller 600 in the liquid crystal display according to an exemplary embodiment of the present invention will now be described in further detail with reference to FIGS. 4-6C.

FIG. 4 is a block diagram of an exemplary embodiment of the image signal compensation unit 650 according to the present invention.

Referring to FIG. 4, the image signal compensation unit 650 includes a memory unit 650a and a compensation unit 650b.

The memory unit 650a includes a plurality of lookup tables (“LUTs’), which, in an exemplary embodiment are automatic color calibration (“ACC”) lookup tables. The compensation unit 650b reads values from the ACC lookup tables in the memory unit 650a to compensate the positive data voltage and the negative data voltage, thereby outputting the compensation image signals R′, G′, B′.

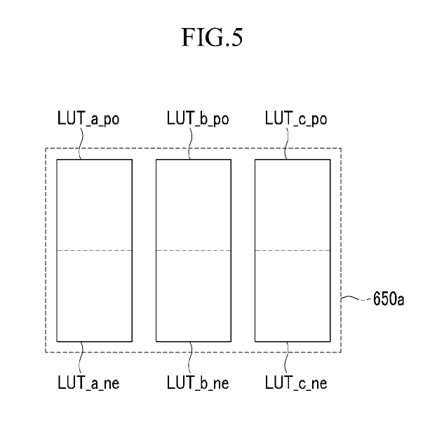

FIG. 5 is a block diagram of an exemplary embodiment of a data table in the memory unit 650a according to the present invention.

Referring to FIG. 5, the memory unit 650a of the image signal compensation unit 650 includes pairs of lookup tables, e.g., a first pair of lookup tables LUT_a_po and LUT_a_ne, a second pair of lookup tables LUT_b_po and LUT_b_ne, and a third pair of lookup tables LUT_c_po and LUT_c_ne. The first pair of lookup tables LUT_a_po and LUT_a_ne relates to the first pixel PX_a including the first color filter 230_{—}a for displaying the first color and includes a first positive lookup table LUT_a_po and a first negative lookup table LUT_a_ne. Similarly, the second pair of lookup tables LUT_b_po and LUT_b_ne relates to the second pixel PX_b including the second color filter 230_{—}b for displaying the second color and includes a second positive lookup table LUT_b_po and a second negative lookup table LUT_b_ne, and the third pair of lookup tables LUT_c_po and LUT_c_ne relates to the third pixel PX_c including the third color filter 230_{—}c for representing the third color and includes a third positive lookup table LUT_c_po and a third negative lookup table LUT_c_ne.

The lookup tables LUT_a_po and LUT_a_ne, LUT_b_po and LUT_b_ne, and LUT_c_po and LUT_c_ne include the lookup tables LUT_a_po, LUT_b_po, and LUT_c_po related to the positive data voltage, and the lookup tables LUT_a_ne, LUT_b_ne, and LUT_c_ne related to the negative data voltage. In an exemplary embodiment shown in FIG. 5, for example, the lookup tables for the signal compensation according to the color displayed in each pixel are separate for the positive data voltage and the negative data voltage, however, in another exemplary embodiment, the lookup table related only to the positive data voltages may be stored, and in this case, the lookup tables related to the positive data voltage may be determined by shifting values in the compensation unit 650b for compensation of the negative data voltage.

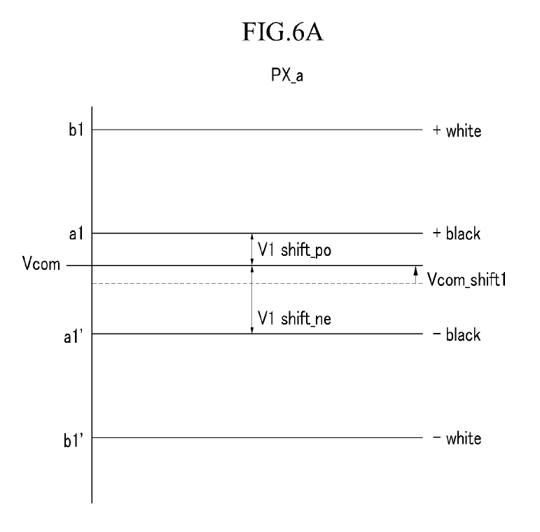

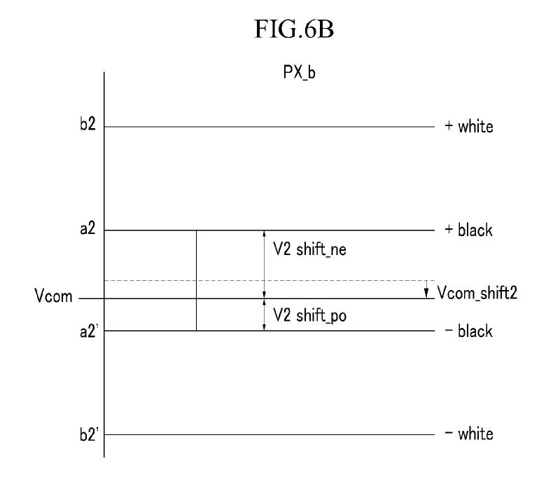

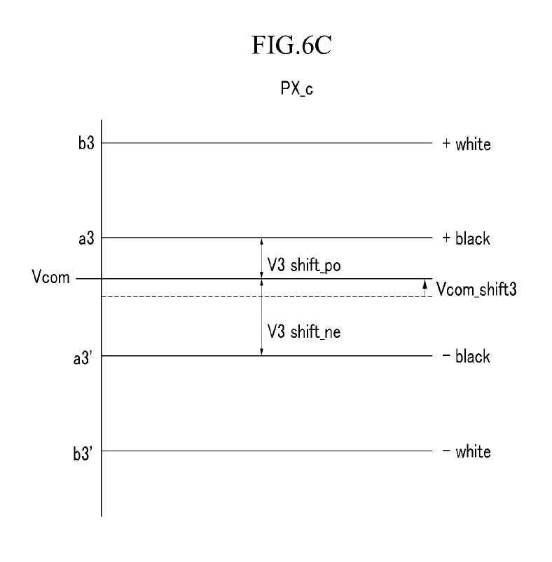

An operation of an exemplary embodiment of the compensation unit 650b of the image signal compensation unit 650 will now be described in further detail with reference to FIG. 6A-FIG. 6C. FIGS. 6A-6C are signal level diagrams showing an exemplary embodiment of a method of compensating the input image signals R, G, B according to the color displayed in each pixel PX in an LCD according to the present invention.

The signal compensation related to the first pixel PX_a, including the first color filter 230_{—}a and representing a first color, such as red (although additional exemplary embodiments are not limited thereto), will now be described in further detail with reference to FIG. 6A. The positive data voltage related to the first pixel PX_a is shifted by the first positive shift V1shift_po as a difference between the common voltage Vcom and a value a1, and the negative data voltage related to the first pixel PX_a is shifted by the first negative shift V1shift_ne as a difference between the common voltage Vcom and a value a1'. In an exemplary embodiment, magnitudes of the first positive shift V1shift_po and the first negative shift V1shift_ne may be different. The shift data may be stored in the first pair of lookup tables LUT_a_po and LUT_a_ne. The compensation unit 650b of the image signal compensation unit 650 reads values the first pair of lookup tables LUT_a_po and LUT_a_ne from the memory unit 650a, and executes color compensation and a gray compensation based on this data. The values in the first pair of lookup tables LUT_a_po and LUT_a_ne are determined according to the thickness of the color filter of the first pixel PX_a such that the compensation of the image signal may be separately applied to the positive data voltage and the negative data voltage according to the first cell gap G_a depending on the thickness of the first color filter 230_{—}a (FIG. 3).

Accordingly, a +black state a1 of the positive data voltage and a −black state a1' of the negative data voltage have different voltage differences with respect to the common voltage Vcom, and a +white state b1 of the positive data voltage and a −white state b1' of the negative data voltage have different voltage differences with respect to the common voltage Vcom. According to the voltage shift, the common voltage Vcom is shifted by a predetermined magnitude Vcom_shift1.

The signal compensation related to the second pixel PX_b including the second color filter 230_{—}b for representing a second color, such as green (although additional exemplary embodiments are not limited thereto) will now be described in further detail with reference to FIG. 6B. The positive data voltage related to the second pixel PX_b is shifted by the second positive shift V2shift_po, and the negative data voltage related to the second pixel PX_b is shifted by the second negative shift V2shift_ne. In an exemplary embodiment, magnitudes of the second positive shift V2shift_po and the second negative shift V2shift_ne may be different. Also, the magnitude of the second positive shift V2shift_po may be different from the magnitude of the first positive shift V1shift_po, and the magnitude of the second negative shift V2shift_ne may be different from the magnitude of the first negative shift V1shift_ne. This difference may be determined according to the difference between the first cell gap G_a and the second cell gap G_b (FIG. 3) depending on the difference of the thicknesses of the first color filter 230_{—}a and the second color filter 230_{—}b, respectively. These shift data may be stored as values in the second pair of lookup tables LUT_b_po and LUT_b_ne. The compensation unit 650b of the image signal compensation unit 650 reads values from the second pair of lookup tables LUT_b_po and LUT_b_ne from the memory unit 650a, and executes the color compensation and the gray compensation based on this data. The second pair of lookup tables LUT_b_po and LUT_b_ne are determined according to the thickness of the second color filter of the second pixel PX_b (FIG. 3) such that the compensation of the image signal may be separately applied to the positive data voltage and the negative data voltage according to the cell gap G_b depending on the thickness of the second color filter 230_{—}b.

Accordingly, the +black state a2 of the positive data voltage and the −black state a2′ of the negative data voltage have different voltage differences with respect to the common voltage Vcom, and the +white state b2 of the positive data voltage and the −white state b2′ of the negative data voltage have different voltage differences with respect to the common voltage Vcom. According to the voltage shift, the common voltage Vcom is shifted by a predetermined magnitude Vcom_shift2. The shift magnitude Vcom_shift2 of the common voltage Vcom for the second pixel PX_b may be different from the shift magnitude Vcom_shift1 of the common voltage Vcom for the first pixel PX_a.

The signal compensation related to the third pixel PX_c that includes the third color filter 230_{—}c for representing a third color, such as blue (although additional exemplary embodiments are not limited thereto), will now be described in further detail with reference to FIG. 6C. The positive data voltage related to the third pixel PX_c is shifted by the third positive shift V3shift_po, and the negative data voltage related to the third pixel PX_c is shifted by the third negative shift V3shift_ne. In an exemplary embodiment, the magnitudes of the third positive shift V3shift_po and the third negative shift V3shift_ne may be different. Also, the magnitude of the third positive shift V3shift_po may be different from the magnitude of the first positive shift V1shift_po or the second positive shift V2shift_po, and the magnitude of the third negative shift V3shift_ne may be different from the magnitude of the first negative shift V1shift_ne or the second negative shift V2shift_ne. This difference may be determined according to the difference of the cell gaps G_a, G_b and G_c according to the thicknesses of the first color filter 230_{—}a, the second color filter 230_{—}b and the third color filter 230_{—}c. These shift data may be stored in the third pair of lookup tables LUT_c_po and LUT_c_ne. Like the first pixel PX_a and the second pixel PX_b, the compensation unit 650b of the image signal compensation unit 650 reads the third pair of lookup tables LUT_c_po and LUT_c_ne from the memory unit 650a, and executes the color compensation and the gray compensation based on this data. The values in the third pair of lookup tables LUT_c_po and LUT_c_ne are determined according to the thickness of the color filter of the third pixel PX_c such that the compensation of the image signal may be separately applied to the positive data voltage and the negative data voltage according to the cell gap G_c depending on the thickness of the third color filter 230_{—}c.

Accordingly, the +black state a3 of the positive data voltage and the −black state a3′ of the negative data voltage have different voltage differences with respect to the common voltage Vcom, and the +white state b3 of the positive data voltage and the −white state b3′ of the negative data voltage have different voltage differences with respect to the common voltage Vcom. According to the voltage shift, the common voltage Vcom is shifted by a predetermined magnitude Vcom_shift3. The shift magnitude Vcom_shift3 of the common voltage Vcom for the third pixel PX_c may be different from the shift magnitude Vcom_shift1 of common voltage Vcom for the first pixel PX_a or the shift magnitude Vcom_shift2 of the common voltage Vcom for the second pixel PX_b.

According to exemplary embodiments of a liquid crystal display as described herein, when a color filter of the liquid crystal display is made of an organic insulator and a thickness of the color filter is different according to a color displayed in each pixel, a positive data voltage and a negative data voltage are compensated according to the color displayed in each pixel, such that the correct and desired color is accurately displayed.

Also, according to the thickness difference of the color filters, an ACC lookup table are used for the compensation of the positive data voltage and the negative data voltage such that the color is compensated without requiring an additional driver or circuit portion, for example, and, accordingly, a cost of the driver of the liquid crystal display according to an exemplary embodiment is substantially reduced.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A driving apparatus for a liquid crystal display including a first pixel, a second pixel and a third pixel which display different colors, the driving apparatus comprising:
an image signal compensation unit which compensates input image signals corresponding to the first pixel, the second pixel and the third pixel to generate compensated input image signals; and
a data driver which supplies data voltages to the first pixel, the second pixel and the third pixel based on the compensated input image signals,
wherein
the image signal compensation unit shifts a value of the input image signal corresponding to the first pixel by a first value with respect to a common voltage,
the image signal compensation unit shifts a value of the input image signal corresponding to the second pixel by a second value with respect to the common voltage, and
the image signal compensation unit shifts a value of the input image signal of the third pixel by a third value with respect to the common voltage.

2. The driving apparatus of claim 1, wherein
the first pixel includes a first color filter which corresponds to a first color,
the second pixel includes a second color filter which corresponds to a second color,
the third pixel includes a third color filter which corresponds to a third color,
the first color filter, the second color filter and the third color filter comprise an organic insulator, and
the first color filter, the second color filter and the third color filter have different thicknesses.

3. The driving apparatus of claim 2, wherein
magnitudes of the first value, the second value and the third value are determined based on the thicknesses of the first color filter, the second color filter and the third color filter, respectively.

4. The driving apparatus of claim 1, wherein
magnitudes of the first value, the second value and the third value, with respect to the common voltage, are different when the respective input image signal has a positive value from when the respective input image signal has a negative value.

5. The driving apparatus of claim 1, wherein
the image signal compensation unit includes:
a memory unit which stores lookup tables corresponding to the first pixel, the second pixel and the third pixel; and
a compensation unit which compensates the input image signals corresponding to the first pixel, the second pixel and the third pixel based on values stored in the lookup tables.

6. The driving apparatus of claim 5, wherein
the first pixel includes a first color filter which corresponds to a first color,
the second pixel includes a second color filter which corresponds to a second color,
the third pixel includes a third color filter which corresponds to a third color,
the first color filter, the second color filter and the third color filter are made of an organic insulator, and
the first color filter, the second color filter and the third color filter have different thicknesses.

7. The driving apparatus of claim 6, wherein
the values stored in the lookup tables are determined based on the thicknesses of the first color filter, the second color filter and the third color filter.

8. The driving apparatus of claim 7, wherein
the lookup tables corresponding to the first pixel, the second pixel and the third pixel are different when the respective input image signal has a positive value from when the respective input image signal has a negative value.

9. The driving apparatus of claim 8, wherein
the lookup table for when the input image signal has the negative value, with respect to the common voltage, includes values, shifted by a predetermined value, from the lookup table for when the input image signals have the positive value.

10. A driving method for a liquid crystal display including a first pixel, a second pixel and a third pixel which display different colors, the method comprising:
receiving input image signals corresponding to the first pixel the second pixel, and the third pixel;
compensating the input image signals corresponding to the first pixel, the second pixel and the third pixel to generate compensated input image signals; and
supplying data voltages to the first pixel, the second pixel and the third pixel based on the compensated input image signals, wherein the compensating the input image signals comprises:
shifting a value of the input image signal corresponding to the first pixel by a first value with respect to a common voltage;
shifting a value of the input image signal corresponding to the second pixel by a second value with respect to the common voltage; and
shifting a value of the input image signal corresponding to the third pixel by a third value with respect to the common voltage.

11. The method of claim 10, wherein
the first pixel includes a first color filter displaying a first color,
the second pixel includes a second color filter displaying a second color,
the third pixel includes a third color filter displaying a third color,
the first color filter, the second color filter and the third color filter comprise an organic insulator, and
the first color filter, the second color filter and the third color filter have different thicknesses.

12. The method of claim 11, wherein
magnitudes of the first value, the second value and the third value are determined based on the thicknesses of the first color filter, the second color filter and the third color filter.

13. The method of claim 12, wherein
the magnitudes of the first value, the second value and the third value, with respect to the common voltage, are different when the respective input image signal has a positive value from when the respective input image signal has a negative value.

14. The method of claim 10, wherein
the compensating the input image signals further comprises:
receiving values corresponding to the first pixel, the second pixel and the third pixel stored in a memory in a lookup table; and
compensating the input image signals corresponding to the first pixel, the second pixel and the third pixel based on the values.

15. The method of claim 14, wherein
the first pixel includes a first color filter displaying a first color,
the second pixel includes a second color filter displaying a second color,
the third pixel includes a third color filter displaying a third color,
the first color filter, the second color filter and the third color filter comprise an organic insulator, and
the first color filter, the second color filter and the third color filter have different thicknesses.

16. The method of claim 15, wherein
the values stored in the lookup tables are determined based on the thicknesses of the first color filter, the second color filter and the third color filter.

17. The method of claim 16, wherein
the lookup tables corresponding to the first pixel, the second pixel and the third pixel are different when the respective input image signal has a positive value from when the respective input image signal has a negative value.

18. The method of claim 17, wherein
the lookup table for when the input image signal has the negative value, with respect to the common voltage, includes values, shifted by a predetermined value, from the lookup table for when the input image signals have the positive value.

19. A driving apparatus for a liquid crystal display including a group of pixels each of which displays different primary color, the driving apparatus comprising:
an image signal compensation unit which compensates input image signals corresponding to each pixels of the group of pixels to generate compensated input image signals; and
a data driver which supplies corresponding data voltages to each pixels of the group of pixels based on the compensated input image signals,
wherein
the image signal compensation unit shifts values of the input image signals corresponding to each pixels of the group of pixels by separate values for each pixels of
the group of pixels with respect to a common voltage.

20. A driving method for a liquid crystal display including a group of pixels each of which displays different primary colors, the method comprising:
receiving input image signals corresponding to the group of pixels;
compensating the input image signals corresponding to each of the group of pixels to generate compensated input image signals; and
supplying data voltages to each of the group of pixels based on the compensated input image signals, wherein the compensating the input image signals comprises:
shifting values of the input image signals corresponding to each pixels of the group of pixels by separate values for each pixels of the group of pixels with respect to a common voltage.
